(19) United States
(12) Patent Application Publication
(10) Pub. No.: US 2020/0137356 A1
(43) Pub. Date: Apr. 30, 2020

(54) POOL TABLE IMAGE CAPTURING SYSTEM

(71) Applicant: MICHAEL T. BUHL, III, FORT WORTH, TX (US)

(72) Inventor: MICHAEL T. BUHL, III, FORT WORTH, TX (US)

(21) Appl. No.: 16/666,039

(22) Filed: Oct. 28, 2019

Related U.S. Application Data
(60) Provisional application No. 62/750,990, filed on Oct. 26, 2018.

(51) Int. Cl. H04N 7/18; H04N 5/225; G06Q 30/02; A63D 15/00

(52) U.S. Cl. CPC H04N 7/183; A63D 15/00; G06Q 30/0241; H04N 5/2253

(57) ABSTRACT

A pool table image capturing system includes a pool table, a lighting fixture, a camera device, and a control unit. The system is configured to disseminate and solicit the sale of captured image data from shots performed on a pool table playing surface. The lighting fixture is located above a portion of the pool table and includes a camera device coupled thereto. The camera device is configured to capture image data from the playing surface. A control unit is in communication with the camera device for the receipt and transmission of the image data. The control unit is configured to regulate dissemination of the image data to remote users.

### CLAIM OF PRIORITY

This application claims the benefit of U.S. Provisional Application No. 62/750,990, filed 26 Oct. 2018. The information contained therein is hereby incorporated by reference.

### BACKGROUND

### 1. Field of the Invention

The present application relates generally to an image capturing system, and in particular a system used to capture images and video of a pool table playing surface that are subsequently stored and available for purchase by players and/or observers.

### 2. Description of Related Art

The game of pool has become a very popular game. The game has grown to be a familiar recreational game as well as a competitive game. Various tournaments and competitions, organized or not, are played. The game of pool incorporates multi-angled shots and deflections that can be difficult to master or even predict. There are times when a shot almost miraculously develops and succeeds in accomplishing its purpose. Most tournaments or recreational playing of pool is not recorded as other national sports leagues are. These shots often go unrecorded and quickly become only a memory.

At tournaments, spectators are typically only able to watch one of a number of tables at a time. This leaves them unable to view the events on another table. As happens during open play, some shots made by a player are considered very exceptional. These can be unexpected. For those not viewing that particular table during the shot, those spectators miss out on the action. The same principle applies to recreational pool playing. There is not a way to capture such moments in time as they are generally unexpected.

Although great strides have been made with respect to the game of pool, considerable shortcomings remain. A new system is needed to help capture and promote the sale of video and images to further promote the sport.

### SUMMARY OF THE INVENTION

It is an object of the present application to provide a pool table image capturing system configured to capture images in video and optional still frame from a live feed camera focused on a pool table. The system is configured to loop the feed and temporarily store images/video which can be accessed by authorized spectators for viewing and purchase with the payment of a small fee. The spectator may use a personal electronic device to link into the system to view and purchase portions of the video. These images and video may be used by the viewer/player through known distribution methods. A network may be formed of multiple cameras, distributed among multiple tables. By permitting the capture and subsequent access to players and spectators of the action on the pool table, the popularity of the sport can be increased through shared moments during open play. Users of the electronic device may pay selected fees for access to the network.

It is a further object of the present application that the system be operated via a number of steps. For example, use of the system may include located the camera device in the lighting fixture and connecting it to the control unit for processing of image data. The data may be solicited to remote users for viewing and dissemination through social media. Proceeds may be distributed through the system to one or more parties.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a view of a pool table image capturing system according to an embodiment of the present application.

FIG. 2 is a chart of the steps of operating the pool table image capturing system of FIG. 1

FIG. 3 is a view of the pool table image capturing system of FIG. 1 within a network.

FIG. 4 is an exemplary schematic of an electronic device used in the pool table image capturing systems of FIGS. 1-3.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the pool table image capturing system of the present application is configured to capture images from a live feed camera focused on a pool table. The system is configured to loop the feed and temporarily store images/video. An electronic device can be linked to the camera in the system to view and purchase portions of the video. These images and video may be used by the viewer/player through known distribution methods. A network may be formed of multiple cameras, distributed among multiple tables. Users of the electronic device may pay selected fees for access to the network. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

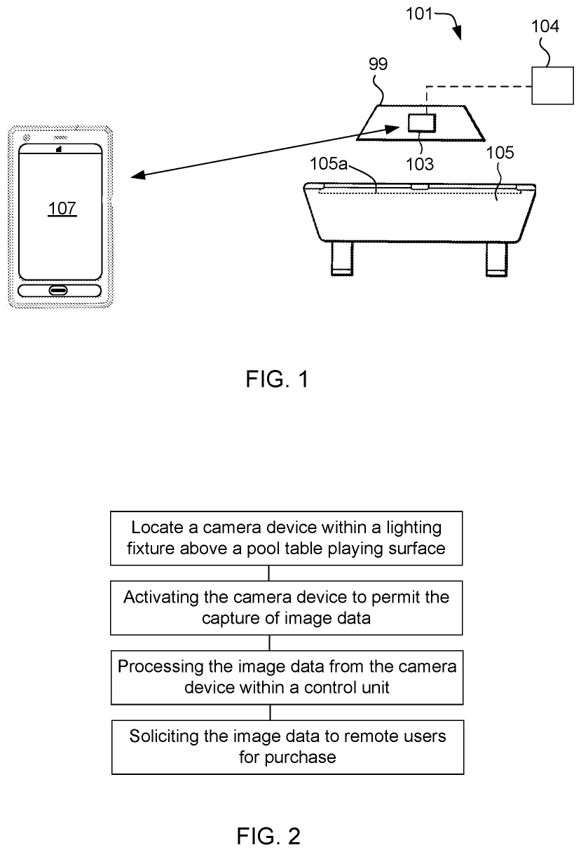

Referring now FIG. 1 in the drawings, a pool table image capturing system 101 is illustrated. The system and method of the present application includes an image capturing device 103 located in an elevated manner over a pool table 105 so as to have a direct line of sight to the playing surface. Also included is a control unit 104 for the capture and transmission of data from device 103. Control unit 104 is used to regulate the distribution of data taken through device 103 to remote electronic devices. It is understood that ideally device 103 can see the entire surface of the pool table. The system 101 is configured to include electronic transmitting capabilities to permit device 103 to transmit and receive electronic data to and from unit 104. An ideal location for device 103 is to be located in the light fixture 99 above table 105.

Referring now also to FIG. 2 in the drawings, a chart of the steps of operation of system 101 is illustrated. In operation, an establishment owner or player locates camera device 103 within lighting fixture 99 above the pool table playing surface 105a. The camera is activated so as to capture image data of the playing surface 105a. The image data is send to control unit 104 for processing. Control unit 104 solicits the image data for purchase to remote observers.

As stated, images and video captured are temporarily stored on a hard drive and categorized or processed for easy sorting and access within control unit 104. The storage is temporary as device 103 is configured to loop the feed and record over prior imagery after a predetermined set time. Example times could be 5 minutes, 30 minutes, 24 hours, and so forth. This time may be adjusted by a user, owner, or operator.

Where system 101 is used by an establishment, device 103 may be integrally secured to fixture 99. Device 103 may be always on or may be selectively turned on or off by the establishment or a player. Image data is captured via device 103 and transmitted to the control unit 104 for processing. Access may be granted to remote users or players to see images and pictures from the playing surface 105a over a period of time. The image data may be purchased by one or more users through a remote electronic device 107 for dissemination and viewing. Proceeds may be distributed to the owner of system 101 and potentially to the establishment according to a predetermined amount.

Where system 101 is used by a player at a random pool table, at the time of a shot that a player wants to capture, the player may access an electronic device (i.e. device 107), open a software application, and access the stored imagery on control unit 104. The user may view past imagery and select the amount and type of imagery that he/she wishes to download. A fee may be collected by system 101 for each download and the proceeds going to the owner of system 101.

It is understood that system 101 may be set to accept payments in various different manners. It is conceived that payments may be required to purchase the software application initially. Users may have limited viewing permissions through the app unless they agree to pay a monthly fee. Another method is to permit unlimited viewing of stored imagery but charge a fee for a download. The fee may be based on the length, type, or size of download. The makers of the software application may share portions of proceeds with establishment owners who use system 101 with their tables 105.

System 101 may be configured such that imagery is uploaded to the “cloud” and accessed through the internet. Imagery purchased would primarily remain with the software application owners and then parsed out to establishments using the system as agreed by contract. It is understood that there are many different types of ways to not only collect fees from system 101, but also to distribute and involve owners.

Referring now also to FIG. 3 in the drawings, system 101 is illustrated within a network of multiple camera devices 103. System 101 operates similarly with multiple device 103 as it does with a single device. This is representative of what a pool hall establishment or other locale with multiple pool tables may be set up as. In this situation, any observer can look at image data captured from any of the devices 103 in the network by knowing its identifier. The identifier may be specific to the location of the network or device or may be unique to each device manufactured. Depending on how system 101 is set up, internet access may be useful in permitting remote access from people not around the particular device. For example, a user does a great shot and wants his buddy in another state to see it. He could text his buddy about it and the buddy can pull it off the system through the internet and the software application associated with control unit 104. It is understood that the network of devices 103 may be coupled to a single control unit 104 or multiple control units 104. Each control unit 104 may be associated with a single device 103 or multiple devices 103.

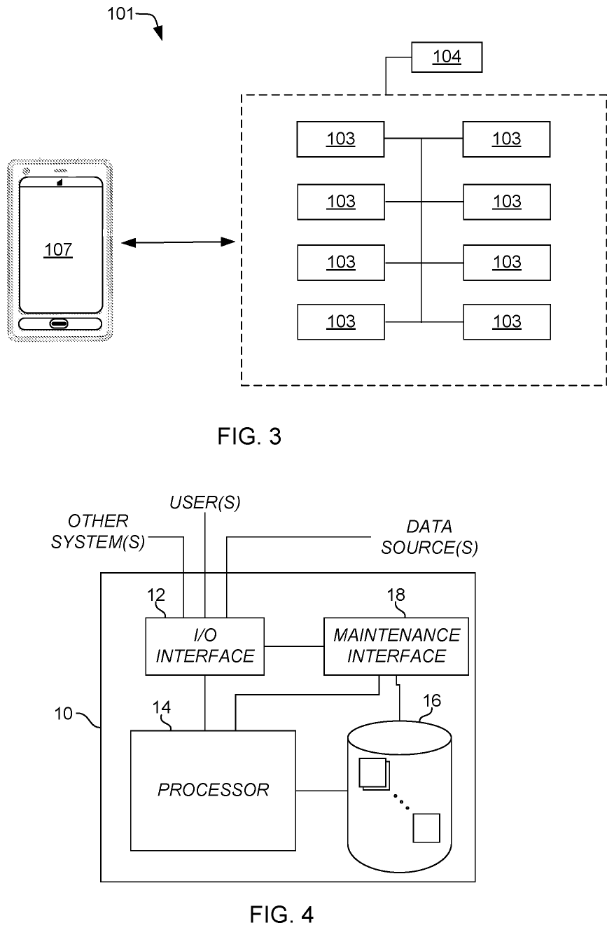

Referring now also to FIG. 4 in the drawings, a schematic of an electronic device used in system 101 is provided. It is understood that the below mentioned exemplary electronic device can equally refer to device 107, device 103, unit 104 and any other part or component used thereby to accomplish the purposes herein described.

As seen in FIG. 4, an exemplary schematic of an electronic device 10 that may be used in system 101 is illustrated. Device 10 may include an input/output (I/O) interface 12, an optimization engine 14, a database 16, and a maintenance interface 18. Alternative embodiments can combine or distribute the input/output (I/O) interface 12, optimization engine 14, database 16, and maintenance interface 18 as desired. Embodiments of the device 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the device 10. The I/O interface 12 can be configured for allowing one or more users to input information to the device 10 via any known input device. Examples can include a keyboard, mouse, touch screen, microphone, and/or any other desired input device. The I/O interface 12 can be configured for allowing one or more users to receive information output from the device 10 via any known output device. Examples can include a display monitor, a printer, a speaker, and/or any other desired output device. The I/O interface 12 can be configured for allowing other systems to communicate with the device 10. For example, the I/O interface 12 can allow one or more remote computer(s) to access information, input information, and/or remotely instruct the device 10 to perform one or more of the tasks described herein. The I/O interface 12 can be configured for allowing communication with one or more remote data sources. For example, the I/O interface 12 can allow one or more remote data source(s) to access information, input information, and/or remotely instruct the device 10 to perform one or more of the tasks described herein.

The database 16 provides persistent data storage for device 10. While the term “database” is primarily used, a memory or other suitable data storage arrangement may provide the functionality of the database 16. In alternative embodiments, the database 16 can be integral to or separate from the device 10 and can operate on one or more computers. The database 16 preferably provides non-volatile data storage for any information suitable to support the operation of the device 10, including various types of data discussed herein.

The maintenance interface 18 is configured to allow users to maintain desired operation of the device 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the optimization engine 14 and/or the I/O interface 12. This can include, for example, software updates and/or administrative tasks such as security management and/or adjustment of certain tolerance settings.

The optimization engine 14 can include various combinations of one or more processors, memories, and software components.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A pool table image capturing system, comprising:
a pool table having a playing surface;
a lighting fixture located above a portion of the pool table;
a camera device coupled to the lighting fixture for viewing the playing surface, the camera device configured to capture image data from the playing surface; and
a control unit in communication with the camera device for the receipt and transmission of the image data, the control unit configured to regulate dissemination of the image data to remote users.

2. The system of claim 1, wherein the camera device is releasably coupled to the lighting fixture.

3. The system of claim 1, wherein the control unit is physically integrated into the camera device.

4. The system of claim 1, wherein the camera device is configured to take pictures.

5. The system of claim 1, wherein the camera device is configured to take video.

6. The system of claim 1, wherein the control unit is coupled to a wireless network.

7. The system of claim 1, wherein the camera device is recording while the lighting fixture is on.

8. A method of capturing imagery from a pool table playing surface, comprising:
locating a camera device within a lighting fixture above the pool table playing surface;
activating the camera device to permit the capture of image data;
processing the image data from the camera device within a control unit; and
soliciting the image data to remote users for purchase

9. The method of claim 8, wherein the image data is a still picture.

10. The method of claim 8, wherein the image data is a video.

11. The method of claim 8, further comprising:
networking a plurality of camera devices together through a single control unit.

12. The method of claim 8, further comprising:
distributing proceeds from the purchase with establishment owners

13. The method of claim 12, wherein proceeds are obtained upon purchase of system software for download on a remote electronic device for viewing the image data.

14. The method of claim 12, wherein proceeds are obtained upon purchase or download of image data onto a remote electronic device.

15. The method of claim 12, wherein the proceeds are dependent upon at least one of a size, length, and type of downloaded image data.

16. The method of claim 8, further comprising:
assigning a unique identifier to the camera device within a network of multiple camera devices.

17. The method of claim 8, further comprising:
providing access to a remote electronic device for viewing the image data.
